(19) United States
(12) Patent Application Publication
(10) Pub. No.: US 2026/0257158 A1
(43) Pub. Date: Sep. 3, 2026

(54) WIRE-WRAPPED SCREEN

(71) Applicant: MSC RESOURCES AB, Gustävberg (SE)

(72) Inventor: Martin SCHUSTER, Oberammergau (DE)

(73) Assignee: MSC RESOURCES AB, Gustävberg (SE)

(21) Appl. No.: 18/862,777

(22) PCT Filed: May 5, 2023
(86) PCT No.: PCT/EP2023/062019

§ 371 Date: Nov. 4, 2024

(30) Foreign Application Priority Data
May 6, 2022 (DE) 10 2022 001 589.7

(51) Int. Cl. B01D 39/12; B01D 39/20

(52) U.S. Cl. CPC B01D 39/12; B01D 39/2027; B01D 2239/0672; B01D 2239/0695

(57) ABSTRACT

The disclosure provides a wire-wrapped screen for filtering crude oil, natural gas, or water, the wire-wrapped screen including at least one tubular support structure made of support elements and at least one wrap wire which is wrapped about the support structure. Preferably, the at least one wrap wire and the support structure made of support elements are welded together. According to the disclosure, the cross-sectional profile of each of the support elements tapers outwards in a conical manner in the radial direction, and the support elements are arranged relative to one another such that the support elements do not contact one another. At least the support structure and the at least one wrap wire consist of boron-treated steel.

### CROSS-REFERENCE TO RELATED APPLICATIONS

This application is related, and claims priority to, PCT application number PCT/EP2023/062019, filed on May 5, 2023, which in turn, claims priority to German patent application 10 2022 001 589.7, filed on May 6, 2022, both of which are incorporated herein by reference in their entireties.

### BACKGROUND

### 1. Field of the Disclosure

The disclosure relates to a wire-wrapped screen for filtering crude oil, natural gas, or water, as well as to a method for producing a wire-wrapped screen. An embodiment of the wire-wrapped screen is recited in claim 1 and a method for producing the wire-wrapped screen is recited in claim 10.

### 2. Background of the Disclosure

Screens for filtering crude oil, natural gas and water from reservoirs are known. In the known screens, occlusions of the screens, deformations, corrosion or erosion of the screen can occur. Thus, there is a need for an improvement of such screens and for an increase in the service lives of the screens.

Therefore, it is an object of the present disclosure to provide a wire-wrapped screen, as well as a method for producing a wire-wrapped screen, which are improved, and to provide a wire-wrapped screen which is more robust and has a longer service life in use.

### SUMMARY

In one embodiment, the disclosure provides a wire-wrapped screen for filtering a fluid comprising crude oil, natural gas, or water, comprising: at least one tubular support structure formed by support elements; at least one wrap wire wound about the support structure, the at least one wrap wire and the support structure formed by the support elements being welded to one another, wherein the cross-sectional profiles of the support elements each taper conically outward in a radial direction and the support elements are arranged relative to each other such that they do not come into contact, and wherein at least the support structure and the at least one wrap wire consist of boron-treated steel. The wire-wrapped screen can include the feature that the cross-sectional profile of the at least one wrap wire tapers conically inward in the radial direction. The wire-wrapped screen can also include the feature that at least for 50% of the surface of the wire-wrapped screen, the minimum distance between two wrap wire windings is between 1 μm and 50 mm. The wire-wrapped screen can further include the feature that the minimum distance between adjacent support elements is larger than the minimum distance between two wire wrap windings. The wire-wrapped screen can further include the feature that an inner perforated pipe is arranged inside the support structure. The wire-wrapped screen can further include the feature the perforated pipe arranged inside the support structure is treated with boron. The wire-wrapped screen can have an outer diameter of between 30 mm and 300 mm. The wire-wrapped screen can include the feature that at least at one of both ends, the wire-wrapped screen is connected, preferably welded, to an end ring. The wire-wrapped screen can also include the feature that the support structure and the at least one wrap wire are made of stainless steel.

The present disclosure has the advantage that the wire-wrapped screen is significantly more robust and shows fewer signs of corrosion and fewer signs of erosion in use. Moreover, the wire-wrapped screen has better filtering properties, whereby occlusions of the filter are less frequent in use. Due to the wire-wrapped screen consisting of boron-treated steel and the boron penetrating into the material of the wire-wrapped screen during boriding, the boron does not detach in use. The overall surface hardness has also improved. The cross-sectional profile of the at least one wrap wire may be tapering conically inward in the radial direction.

At least for 50% of the surface of the wire-wrapped screen, the minimum distance between two wrap wire windings can be between 1 μm and 50 mm. The minimum distance may also be referred to as slot width. The size of the minimum distance depends on the particle size of the surrounding area from which the medium is to be filtered. In this way, filtering crude oil, natural gas and water can be performed in an optimal manner.

The minimum distance between two adjacent support elements can be larger than the minimum distance between two wrap wire windings. An inner, perforated pipe can be arranged inside the support structure. When arranged within the support structure, the pipe provided can also be treated with boron or consist of boron-treated steel.

The outer diameter of the wire-wrapped screen can be between 30 mm and 300 mm. Preferably, at least one of the two ends of the wire-wrapped filter can be connected, preferably welded, to an end ring. The support elements and the wrap wire can be made of stainless steel.

In one embodiment, the disclosure provides a method for producing a wire-wrapped screen is provided, the method comprising the following steps: providing support elements made of steel, each having cross-sectional profiles that each taper conically; arranging the support elements such that the arranged support elements form the shape of a tubular support structure and the cross-sectional profiles of the support elements each taper conically outward in the radial direction, the support elements being spaced apart and not in contact with each other; maintaining the support elements in the arranged shape using a holding device; providing at least one wrap wire consisting of steel; wrapping the wrap wire about the arranged support elements held by the holding device; connecting the wrap wire to the support elements using a welding technique; removing the holding device; and treating the wire-wrapped screen with boron.

The boron treatment can comprise the following steps: placing the support elements and the wrap wire connected to the support elements into a closed furnace; and heating in the presence of a boriding agent.

During heating, the furnace can be heated to a temperature of 750 to 950° C.

The at least one wrap wire can be produced such that the cross-sectional profile of the at least one wrap wire tapers conically inward in the radial direction. The at least one wrap wire can be wrapped about the support elements such that for at least 50% of the surface of the wire-wrapped screen, the minimum distance between two wrap wire windings is between 1 μm und 50 mm, preferably between 100 and 300 μm.

The support elements can preferably be arranged with respect to each other and the wrap wire can be wound about the support elements such that the minimum distance between adjacent support elements is larger than the minimum distance between two wrap wire windings.

### BRIEF DESCRIPTION OF THE FIGURES

The present disclosure can be further understood by an embodiment of the present disclosure described in more detail with reference to the Figures.

FIG. 1 shows a wire-wrapped screen according to the disclosure with connection elements.

FIG. 2 shows a wire-wrapped screen according to the disclosure.

FIG. 3 shows a detail of FIG. 1 showing an end of the wire-wrapped screen.

FIG. 4 shows a cross-sectional view on a wire-wrapped screen of FIG. 1.

FIG. 5 shows a detail of a longitudinal section of FIG. 1.

FIG. 6 shows cross sections of the support elements and the wrap wire.

FIG. 7 shows a surface analysis before an erosion test.

FIG. 8 shows the surface analysis after a 2-hour erosion test.

FIG. 9 shows the surface analysis after a 48-hour erosion test.

FIG. 10 shows the macro image after a 48-hour erosion test.

### DETAILED DESCRIPTION OF THE DISCLOSURE

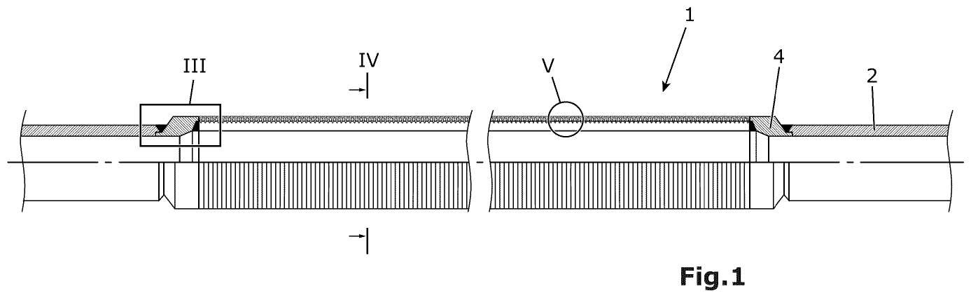

FIG. 1 shows a wire-wrapped screen 1 with connection elements 2. End rings 4 are provided at the ends of the wire-wrapped filter 1. Wire-wrapped screens can be used to filter reservoirs of crude oil, natural gas or water. For this purpose, they can be connected to connection elements 2.

In an alternative embodiment not illustrated, the outer diameter of the wire-wrapped screen 1 can also be adapted to the outer diameters of the connection elements 2. Moreover, the end ring 4 can in addition be adapted to the outer diameter of the wire-wrapped screen 1.

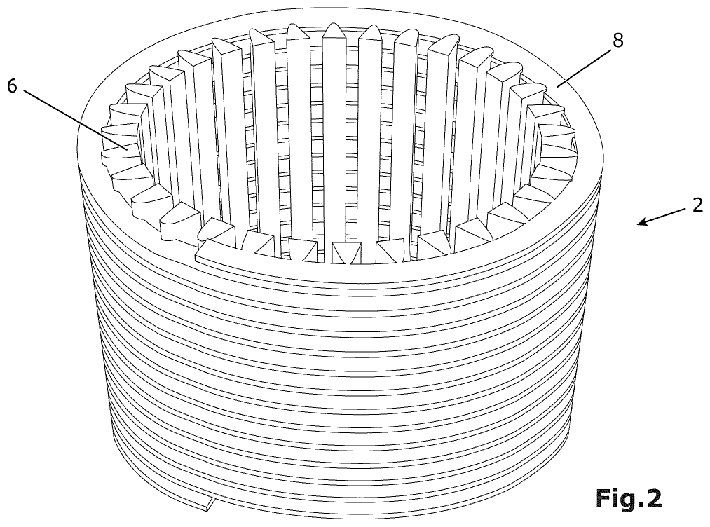

The wire-wrapped screen 1 is shown in perspective in FIG. 2 without the connection elements 2. It can be seen in FIG. 2 that the wire-wrapped screen 1 comprises support elements 6 forming a tubular support structure. Further, at least one wrap wire 8 is provided which is wound about the support structure, the at least one wrap wire 8 and the support structure formed by support elements 6 being welded together. The cross-sectional profiles of the support elements 6 each taper conically outward in the radial direction and the support elements 6 are arranged such with respect to each other that they do not contact each other. The at least one support element 6 and the at least one wrap wire 8 consists of boron-treated steel.

Due to the wire-wrapped screen 1 consisting of boron-treated steel and the boron penetrating into the material of the wire-wrapped screen 1, the boron does not detach in use. The wire-wrapped screen of the disclosure is significantly more robust and shows fewer signs of corrosion and erosion in use. Due to the entire wire-wrapped screen 1 being boron-treated, the entire wire-wrapped screen 1 has a particularly high surface hardness. The boron treatment does not round the edges of the wrap wire 8, but the edges remain sharp. This differs from a coating, in which the edges would be rounded by the coating. Due to the sharp edges of the wrap wire 8, fewer turbulences in the fluid occur in use. The pressure loss is less and the flow is improved.

Further, it can well be seen in FIG. 2 that at least for 50% of the surface of the wire-wrapped screen 1, the minimum distance between two wrap wire 8 windings can be between 1 μm and 50 mm. In the embodiment illustrated, the minimum distance between two wrap wire 8 windings is between 1 μm and 50 mm over the entire surface. It is particularly preferred that for at least for 50% of the surface of the wire-wrapped screen 1, the minimum distance between two wrap wire 8 windings is between 100 μm and 300 mm. In this way, filtering crude oil, natural gas and water can be performed in an optimal manner.

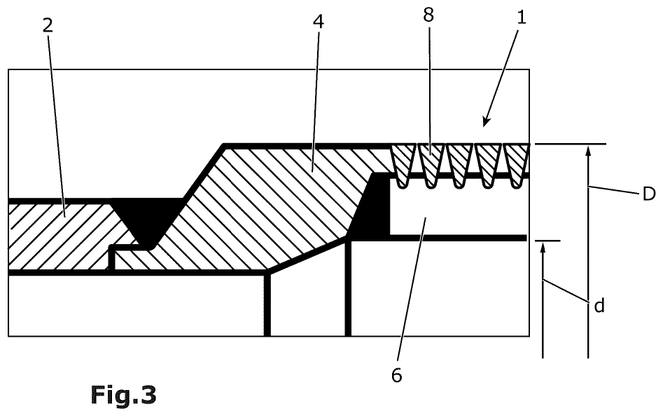

FIG. 3 illustrates a detail of an end of the wire-wrapped screen 1 of FIG. 1. There, an end ring 4 is connected to the wire-wrapped filter 1, preferably welded. Moreover, the end ring 4 is connected to further connection elements 2. Further, FIG. 3 also shows a detail of a longitudinal section of the wire-wrapped screen 1. A longitudinal section will also be described in more detail with reference to FIG. 5. The wire-wrapped screen 1 has an outer diameter (D) and an inner diameter (d). Moreover, FIG. 3 shows a section through the wire-wrapped screen 1. Furthermore, the cross section runs between two adjacent support elements 6, so that a side view of a support element 6 can be seen in FIG. 3.

The outer diameters of the wire-wrapped screens are typically indicated in inches. 1″ equals 2.54 cm. The diameters of the wire-wrapped screen 1 can have an outer diameter preferably between 1″ and 15″, in particular between 1.5″ and 10″, particularly preferred between 1.9″ and 7⅝″. More specifically, the wire-wrapped screen can have the following preferred outer diameters: 1.9″, 2⅜″, 2⅞″, 3½″, 4½″, 5½″, 7.00″, 7⅝″. However, the wire-wrapped screen can also have any desired outer diameter in between.

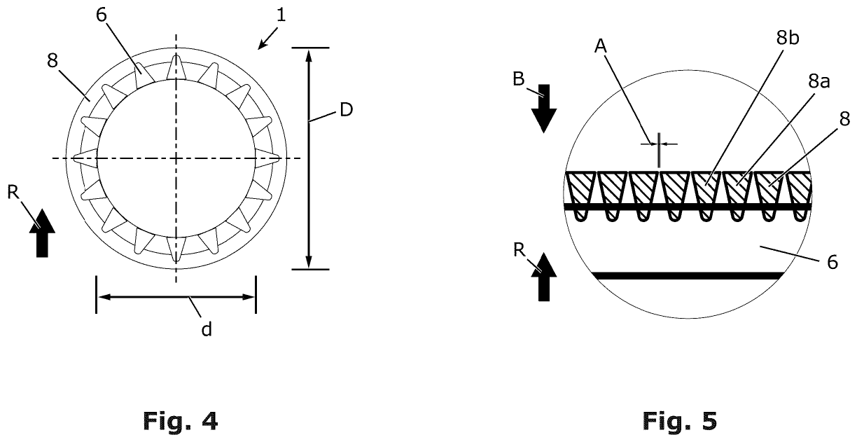

FIG. 4 is a cross-sectional view of a wire-wrapped screen 1. There, the support elements 6 that form a tubular support structure are illustrated in cross section. Likewise, a view on the at least one wrap wire 8 can be seen. The support elements 6 taper conically outward in the radial direction (R). It can further be seen that the support elements 6 are spaced apart. Due to the cross-sectional profiles and the arrangement of the support elements 6 and the wrap wire 8 relative to each other, as provided by the disclosure, the wire-wrapped screen 1 has particularly good flow properties. Due to the good flow properties, fewer signs of erosion occur.

FIG. 5 is a longitudinal section of the wire-wrapped screen 1. The at least one wrap wire 8 is shown in section, respectively, and a view on at least one support element 6 can be seen. For 50% of the surface of the wire-wrapped screen 1, the minimum distance A between two wrap wire windings 8a, 8b can be between 1 μm and 50 mm. Also, the cross-sectional profile of the at least one wrap wire 8 may be tapering conically inward in the radial direction (R). Thus, the cross-sectional profiles of the support elements taper conically outwards in the radial direction (R), whereas the cross-sectional profiles of the at least one wire-wrapped screen 1 taper conically inward in the radial direction (R).

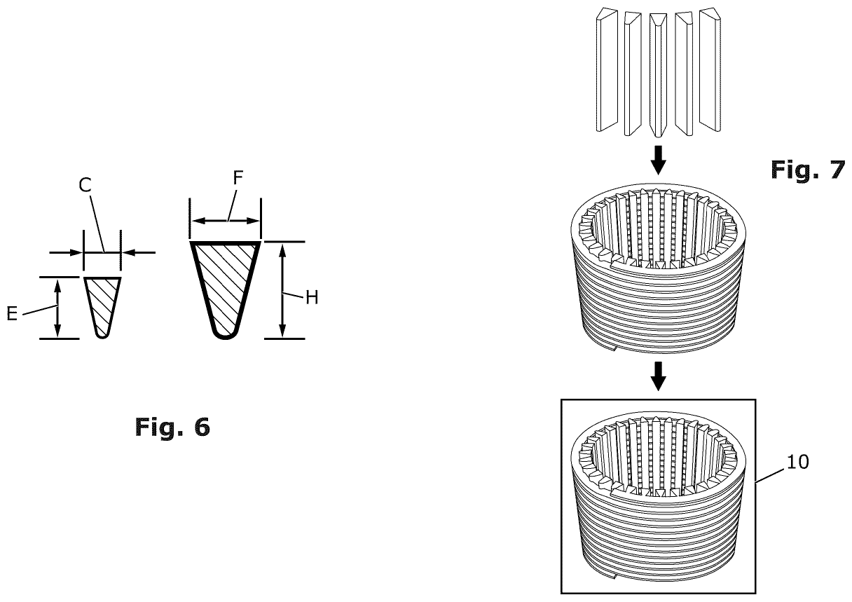

FIG. 6 shows the cross-sectional profiles of the at least one wrap wire 8 and the support elements 6. The width (C) of the wrap wire 8 is preferably less than the width (F) of the support elements 6. Further, also the height (E) of the at least one wrap wire 8 is preferably smaller than the height (H) of the support elements 6. The cross-sectional profiles of the at least one wrap wire 8 and the at least one support element 6 have similar shapes, namely a conically tapering shape. As already described before with reference to the previous Figures, the cross-sectional profiles are, however, arranged differently, so that the cross-sectional profile of the support elements tapers conically outwards, whereas the cross-sectional profile of the at least one wrap wire tapers conically inward.

FIG. 7 shows the steps of a method for producing a wire-wrapped screen 1. In the first step, support elements 6 of steel are produced, their cross-sectional profiles tapering conically. Then, the support elements 6 are arranged such that the arranged support elements 6 form the shape of a tubular support structure and the cross-sectional profiles of the support elements 6 each taper conically outward in the radial direction, the support elements 6 being spaced apart and not in contact with each other. These support elements 6 are maintained in the arranged shape using a holding device (not illustrated).

In a further step not illustrated, at least one wrap wire 8 of steel is produced. The wrap wire 8 same is wound about the support elements 6 held by means of the holding device, and the wrap wire 8 is connected to the support elements 6 using a welding method. In the second image oof FIG. 7, the support elements 6 are illustrated after connection to the wrap wire 8.

Thereafter, the holding device is removed and the wire-wrapped screen 1 is treated with boron. Here, a wire-wrapped screen 1 is preferably arranged in a closed furnace 10 and the furnace 10 is heated in the presence of a boriding agent. This is illustrated in the third image of FIG. 7. The furnace temperature upon heating is preferably between 75° and 950° C. and the wire-wrapped screen is thus treated with the chemical element boron at a temperature of preferably 750 to 950° C., so that boron penetrates into the upper layers of the wire-wrapped screen 1. These layers are preferably 100 to 250 μm thick. In this manner, a robust wire-wrapped screen 1 is formed.

### Example

An erosion test was performed on the wire-wrapped screen 1 of the disclosure. An erosion test was performed as described in the publication “Performance of Ceramic Sand Screen for High Rate Gas Application—Gas Sand Screen Erosion Testing” Nickolas Manning; Paul Cadogan; Peter Barth; Ben Hoskin; Trent Read; David Manning; Richard Jackson; Bhargava Gundemoni; SPE Asia Pacific Oil and Gas Conference and Exhibition, Brisbane, Australia, October 2018. Paper Number: SPE-191942-MS.

In the publication, an erosion test and its application for the evaluation of the erosion resistance is described. The erosion test was developed to simulate “accelerated” erosion conditions in a bore hole. A gas-sand mixture is merged at a high flow rate in an acceleration pipe. The sand particles impinge on the screen to be tested at a high velocities (>80 m*s⁻¹). In this paper, the erosion test was performed for 48 hours at maximum velocity (>80 m*s⁻¹) and a sand concentration of 750 ppmw. It should be moted that the velocities mentioned in this report are significantly higher than those a conventional reservoir system would have to tolerate.

In the erosion test, the test installation is operated with compressed air. The main airflow is controlled via a volumetric flow controller. A secondary airflow is supplied to the controller in a bypass and is used for the injection of sand. The sand mass flow is adjusted using a sand metering device with a worm gear and is supplied to the bypass at atmospheric pressure. After the main and secondary airflows are merged, the air-sand mixture is passed through a horizontal pipe route in which the particles are accelerated, thereby reaching the set impact velocity. The erosion of test screens takes place in a sample chamber at the end of the pipe route, where the air-sand mixture impinges vertically on the screen surface. The design of the sample chamber causes the majority of the particles to be separated directly on the floor of the chamber. The particles remaining in the air are removed from the exhaust airflow in a downstream cyclone.

### Test Conditions for the Erosion Tests:

| | | |
|---|---|---|
| Gas flow volume | 102 | m³/h |
| Injected sand volume | 1.48 | g/min |
| Percent by weight of the sand | 750 | ppmw |
| Test temperature | 298.15 | K |
| Particle size (sand) | 100 | μm |

| | |
|---|---|
| Impact velocity | 80 m/s to 100 m/s |
| Impact angle | 90° |

For the test, the surface profiles of sections of the wire-wrapped screen 1 of the disclosure were generated before and after the erosion test, using a microscope Keyence VHX 2000. Two erosion tests were performed, one erosion test of 2 hours and another erosion test of 48 hours. All erosion tests were performed under the above-mentioned conditions.

First, the first surface profile analysis of the wire-wrapped screen 1 is performed before the first erosion test so as to be able to compare the wire-wrapped screen 1 with later measurements and to detect possible damage. In this analysis, a strip along the wire-wrapped screen 1 surface is measured and a 3D model is generated. Thereafter, the wire-wrapped screen 1 is placed into the test chamber. It is fastened to the cover of the sample chamber by means of a further flange so that the screen cannot move and the volumetric flow can impinge on the screen without obstruction.

In order to be able to start up the test device, the volumetric flow controller is set to the desired value first. Upon reaching this value, the required mass flow of sand is injected into the airflow via an ejector using a sand doser. The screen is blasted—as indicated—either for a period of 2 hours or 48 hours.

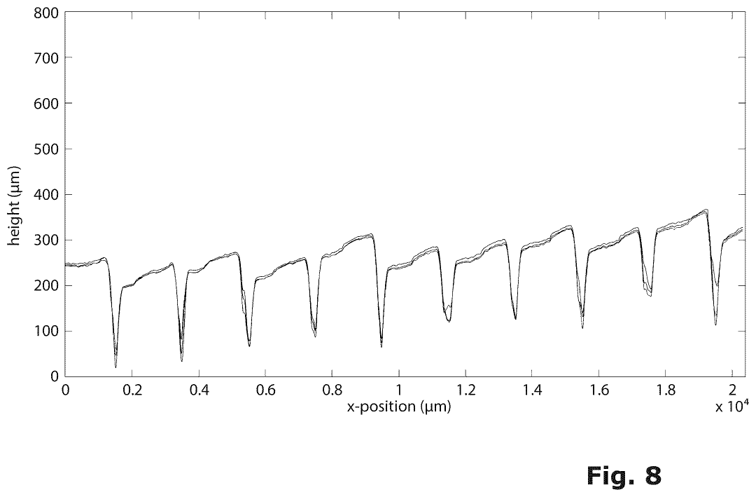

Prior to performing an erosion test, the surface analysis shows a height difference of up to 100 μm between the webs of the wire-wrapped screen 1 (see, FIG. 8).

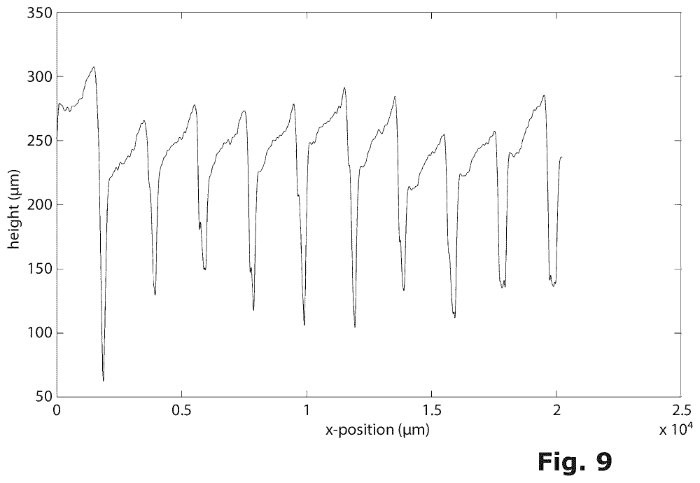

FIG. 9 shows the surface profile of the same wire-wrapped screen 1 section after the 2-hour erosion test. The surface shows no significant change. The height difference of the individual webs is even slightly smaller than before. Similarly, no surface erosion can be measured along the profile line after the 48-hour erosion test. The roughness of the individual webs decreases even more. The height difference between the raised surface and the surface not raised is less than 50 μm. The three different lines in the Figures show the results of three parallel comparison measurements. It should be noted that the scale of the measurement varies in FIGS. 8-10.

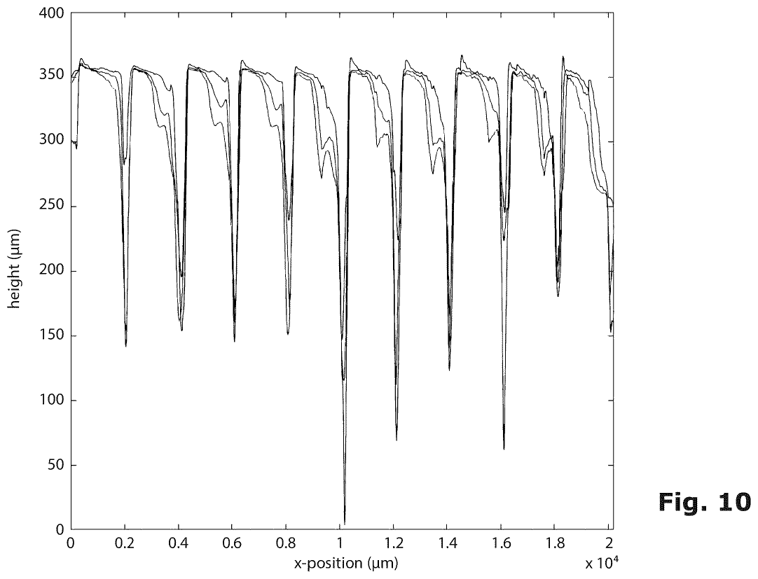

FIG. 10 is a macro image of the wire-wrapped screen 1 after the 48-hour erosion test. A slight wear of the surface can be detected at the point where the sand flow impinges on the screen. A comparison of the blasted and the non-blasted screen surface shows no significant height difference indicating erosion. Both during a 2-hour and a 48-hour treatment, erosion is so little that it is covered by the initial un-evenness of the individual webs. Only a surface measurement of the screen sample blasted for 48 hours shows a surface that is slightly more uniform than the original sample, which could indicate a marginal erosion.

However, overall, the wire-wrapped screen 1 has a very good erosion resistance.

1.-15. (canceled)

16. A wire-wrapped screen for filtering crude oil, natural gas, or water, comprising:
at least one tubular support structure formed by support elements); and
at least one wrap wire wound about the support structure, the at least one wrap wire and the support structure formed by the support elements being welded to one another, wherein the support elements each has a cross-sectional profile that tapers conically outward in the radial direction, wherein the support elements are arranged relative to each other so that they do not come into contact, and wherein at least the support structure and the at least one wrap wire consist of boron-treated steel.

17. The wire-wrapped screen according to claim 1, wherein the cross-sectional profile of the at least one wrap wire tapers conically inward in the radial direction.

18. The wire-wrapped screen according to claim 1, wherein at least for 50% of the surface of the wire-wrapped screen, the minimum distance (A) between two wrap wire windings is between 1 μm and 50 mm.

19. The wire-wrapped screen according claim 1, wherein the minimum distance between adjacent support elements is larger than the minimum distance (A) between two wire wrap windings.

20. The wire-wrapped screen according to claim 1, further comprising a perforated pipe arranged inside the support structure.

21. The wire-wrapped screen according to claim 20, wherein the perforated pipe arranged inside the support structure is treated with boron.

22. The wire-wrapped screen according to claim 1, wherein wire-wrapped screen has an outer diameter that is between 30 mm and 300 mm.

23. The wire-wrapped screen according to claim 1, wherein the wire-wrapped screen has at least at one end that is connected to an end ring.

24. The wire-wrapped screen according to claim 1, wherein the support structure and the at least one wrap wire are made of stainless steel.

25. A method for producing a wire-wrapped screen, the method comprising:
providing support elements made of steel, each having cross-sectional profiles that each taper conically:
arranging the support elements so that the arranged support elements form the shape of a tubular support structure and the cross-sectional profile of the support elements each tapers conically outward in the radial direction, wherein the support elements are spaced apart and not in contact with each other;
maintaining the support elements in the arranged shape using a holding device;
providing at least one wrap wire consisting of steel;
wrapping the wrap wire around the arranged support elements held by the holding device;
connecting the wrap wire to the support elements by welding;
removing the holding device; and
treating the wire-wrapped screen with boron.

26. The method according to claim 25, wherein the boroin treatment comprises the following steps:
placing the support elements and the wrap wire connected to the support elements into a closed furnace; and
heating in the presence of a boriding agent.

27. The method according to claim 26, wherein the heating is up to between 750 to 950° C.

28. The method according to claim 25, wherein at least one wrap wire is produced so that the cross-sectional profile of the at least one wrap wire tapers conically inward in the radial direction.

29. The method according to claim 28, wherein the at least one wrap wire is wrapped about the support elements so that for at least 50% of the surface of the wire-wrapped screen, the minimum distance between two wrap wire windings is between 1 μm und 50 mm.

30. The method according to claim 25, wherein the support elements are arranged with respect to each other and the wrap is wound about the support elements so that the minimum distance between adjacent support elements is larger than the minimum distance between two wrap wire windings.
